(19) United States
(12) Patent Application Publication
(10) Pub. No.: US 2020/0270147 A1
(43) Pub. Date: Aug. 27, 2020

(54) SYSTEM AND METHOD FOR CREATING CAVITATION IN A FLUID

(71) Applicant: Michael Smith, Placentia, CA (US)

(72) Inventor: Michael Smith, Placentia, CA (US)

(21) Appl. No.: 15/774,574

(22) PCT Filed: Dec. 15, 2016
(86) PCT No.: PCT/US16/67027

§ 371 Date: Jun. 13, 2019

(51) Int. Cl. C02F 1/34; C02F 1/68; B01F 3/04; B01F 5/00

(52) U.S. Cl. CPC C02F 1/34; C02F 1/68; B01F 1/00; B01F 5/0057; B01F 3/0446

(57) ABSTRACT

A system for remediation of a fluid is provided. The system has an inlet configured to supply the fluid to a remediation channel, an injection port in fluid communication with the remediation channel, the injection port configured to inject at least one substance into the liquid, at least on air actuator in fluid communication with the remediation channel downstream from the injection port, the air actuator configured to generate a cavitation pocket, a vortex plate disposed within the remediation channel, and configured to create a swirl in the fluid and further increase the number of cavitation pockets within the liquid. A method of remediating a fluid is also provided herein.

### CROSS-REFERENCE TO RELATED APPLICATIONS

This application claims the benefit of and is a National Stage Filing of PCT application No. PCT/US16/67027, entitled System and Method for Creating Cavitation in a Fluid filed Dec. 15, 2016, the entire contents of which are incorporated by reference herein for all purposes.

### FIELD OF THE INVENTION

The present invention relates generally to remediation of fluids, and more particularly, a system and method for creating, concentrating, and/or controlling hydrodynamic cavitation in a fluid in a variable manner.

### BACKGROUND OF THE INVENTION

The many diverse activities of humans produce innumerable waste materials and by-products. As the environmental, health, and industrial impact of pollutants increase, it has become increasingly important to develop new methods for the rapid and efficient removal of a wide range of contaminants from polluted waters and other liquids. Remediation, as it is often referred to, aims to reduce or eliminate pollutants and other unsafe materials from fluid

Many methods of remediation exist. Some biological treatment techniques include bioaugmentation, bioventing, biosparging, bioslurping, and phytoremediation. Some chemical treatment techniques include ozone and oxygen gas injection, chemical precipitation, membrane separation, ion exchange, carbon absorption, aqueous chemical oxidation, and surfactant enhanced recovery. Some chemical techniques may be implemented using nanomaterials. Physical treatment techniques include, but are not limited to, pump and treat, air sparging, and dual phase extraction.

One such method that has recently been gaining in popularity due to its environmentally friendly nature is hydrodynamic cavitation. Cavitation, generally, is the formation of vapor cavities in a liquid that creates small liquid-free zones. In engineering terminology, the term cavitation is used in a narrower sense, namely, to describe the formation of vapor-filled cavities in the interior or on the solid boundaries created by a localized pressure reduction produced by the dynamic action of a liquid system.

While a few cavitation methods currently exist (e.g., acoustic cavitation) hydrodynamic cavitation is relatively less explored. In hydrodynamic cavitation, decontamination may be achieved through the use of submerged jets which trigger hydrodynamic cavitation events in the liquid. These cavitation events drive chemical reactions by generating strong oxidants and reductants, and efficiently decomposing and destroying contaminating organic compounds, as well as some inorganics. These same cavitation events both physically disrupt or rupture the cell walls or outer membranes of microorganisms (such as E. coli and salmonella) and larvae (such as Zebra mussel larvae), and also generate bactericidal compounds, such as peroxides, hydroxyl radicals, etc., which assist in the destruction of these organisms. Following disruption of the cell wall or outer membrane, the inner cellular components are susceptible to oxidation.

Hydrodynamic cavitation is defined by formation of cavities formed with vapor-gas inside the fluid flow, or at the boundary layer, of an area of localized pressure, which is reduced below the vapor pressure for the fluid. The localized pressure drop is affected by increasing fluid velocity through a constriction in flow area (i.e. at or before a vena contracta). When the cavity filled fluid moves to an area of pressure that is higher than the vapor pressure for the fluid (e.g. an area of greater cross-sectional area, lower fluid velocity, and thus higher pressure) the vapor-gas cavities condense back into fluid and collapse.

There are several theories for the cause of the chemical reactions that take place upon the bubble collapse. According to one, the generation of a “hot spot” upon bubble collapse (local high temperature and pressure region) is responsible for the enhanced reactions. According to this theory, the collapse of the myriad of bubbles in the cavitated region creates a multitude of localized high temperature and high-pressure spots (up to 5,000° C. and 1,000 atmospheres) that achieve the oxidation (and/or reduction) and thus the desired remediation effects. Other theories of cavitation suggest that the reactions are generated by shock waves or electric discharges generated at the bubble collapse, or to the formation of a plasma-like state in the collapsing bubble. Regardless of causation, the physical and chemical reactions that take place at the site of the cavitation event are efficiently utilized in the process of the present invention for the elimination of organic and other contaminants from the liquids.

As described by U.S. Pat. No. 6,221,260 to Chahine et al., the characteristics and behavior of the generated cavities strongly affect oxidation efficiency. Due to the low pressures generated at the center of the swirl chamber, aggressive cavitation can be generated at moderate jet pressures with no need to reduce the ambient pressure (for purposes of this invention, “ambient pressure” refers to the pressure of the liquid into which the fluid jet issues). In operation at low to moderate ambient pressures (i.e., about 0 to 100 psi), the swirling fluid jet cavitation used in this remediation method nevertheless generates high volumes of small cavities or cavities whose morphology exhibits a large surface area to volume ratio (e.g., very elongated bubbles, helical patterns, etc.).

Cavitation technology has uses in a wide variety of industrial and ecological remediation settings, including but not limited to farming, mining, pharmaceuticals, food and beverage manufacture and processing, fisheries, petroleum and gas production and processing, water treatment and alternative fuels. With such a wide field of use, companies have been increasingly eager to further develop cavitation technologies.

Some examples include the use of rotating jet nozzles for cleaning and maintenance purposes disclosed in U.S. Pat. No. 5,749,384 (Hayasi, et al.) and U.S. Pat. No. 4,508,577 (Conn et al.). The apparatus of Hayashi employs a driving mechanism capable of causing the jet nozzle itself to travel upward-and-downward, to rotate and swing. Conn et al. describe the rotation of a cleaning head including at least two jet forming means, for cleaning the inside wall of a conduit.

These current hydrodynamic cavitation technologies, in many cases, aim to reduce particle distribution size distribution of suspended solids. Due in part to the complex nature of complex systematic nature of this nexus of fluid dynamics and thermodynamics, today's known cavitation devices are inefficient due to high energy requirement, and further, are known to be costly and over-sized, and are not variable in nature.

Accordingly, there is a need for an improved cavitation device that is both efficient and economical, and footprint reducing, while also creating, controlling, and concentrating the qualitative and quantitative effects of hydrodynamic cavitation.

### SUMMARY OF THE INVENTION

Various embodiments are presented of a method and apparatus for creating cavitation in a fluid.

In an embodiment of the present invention, a system for remediation of a fluid is provided, the system comprising an inlet configured to supply the fluid to a remediation channel, an injection port in fluid communication with the remediation channel, the injection port configured to inject at least one substance into the liquid, at least on air actuator in fluid communication with the remediation channel downstream from the injection port, the air actuator configured to generate a cavitation pocket, a vortex plate disposed within the remediation channel, and configured to create a swirl in the fluid and further increase the number of cavitation pockets within the liquid.

A method for remediation of a fluid is also provided. The method comprises flowing a fluid through a remediation channel starting at an inlet, injecting at least one substance into the fluid using an injection port in fluid communication with the remediation channel, introducing bursts of air into the fluid using air actuator in fluid communication with the remediation channel downstream from the injection port, generating a vortex and cavitation pocket in the fluid within the remediation channel, inducing a second vortex in the fluid using a vortex plate disposed within the remediation channel, and configured to create a swirl in the fluid and further increase the number of cavitation pockets within the liquid.

This method is useful in areas such as industrial and ecological remediation settings, including, for example, farming, mining, pharmaceuticals, food and beverage manufacture and processing, fisheries, petroleum and gas production and processing, water treatment and alternative fuels. Particularly, the method is useful where the physical and chemical reactive properties of cavitation would be beneficial.

Other features, advantages, and aspects of the present invention will become more apparent and be more readily understood from the following detailed description, which should be read in conjunction with the accompanying drawings.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a fluid remediation and/or treatment system in accordance with an embodiment of the present invention;

FIG. 2 is a perspective view of a vortex plate in accordance with an embodiment of the present invention;

FIG. 3 is a schematic diagram of the fluid water treatment system of FIG. 1 “scaled-up” in accordance with an embodiment of the present invention;

FIG. 4 is line schematic view of a fluid remediation and/or treatment system in accordance with an embodiment of the present invention;

FIG. 5 is a step-wise flow chart for a method of fluid remediation and/or treatment system in accordance with an embodiment of the present invention;

FIG. 6 is a schematic diagram of a use case detailing remediation in a farm using of a fluid remediation and/or treatment system in accordance with an embodiment of the present invention;

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

While exemplary embodiments of the present invention will be described with reference to certain industries in which cavitational finds use, a skilled artisan will realize that embodiments of the invention are applicable to any type application in which cavitation is beneficial.

The system and method of the present invention create hydrodynamic cavitation in fluids. The detailed elements and specific embodiments of the present decontamination system can be best appreciated by further understanding the cavitation phenomenon employed to drive the physical and chemical decontamination reactions. Due to large pressure drop in flow, microscopic bubbles grow in the regions of pressure drop and collapse in the regions of pressure rise. When subjected to cavitation, various molecules in the liquid undergo dissociation and form free radicals, which are powerful oxidizing or reducing agents. For example, in aqueous liquids, the dissociation of water to form hydroxyl radicals occurs under intense cavitation due to the growth and collapse of microscopic bubbles. Analogous dissociation of other molecules may occur as a result of cavitation in aqueous solutions as well as in non-aqueous liquids and solutions, producing radicals which similarly aid in the decontamination reactions described herein. Moreover, cavitation generated in any liquid environment will result in the physical disruption of contaminants, without regard to the generation of particular radicals. The methods and systems of this invention will be applicable for all fluid environments comprising contaminants susceptible to decomposition via the physical and/or chemical effects of the cavitation employed.

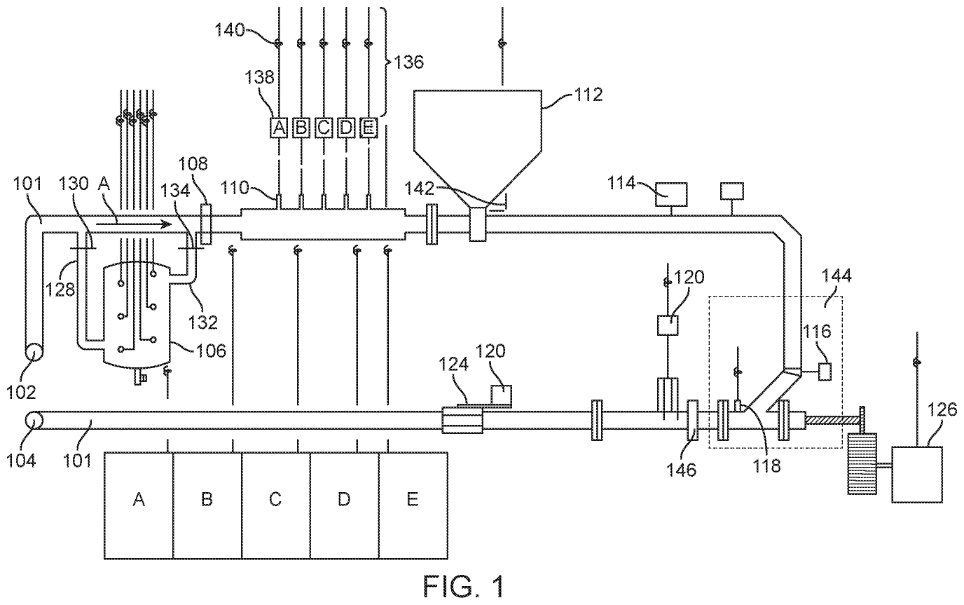

Referring now to FIG. 1, a system for treating water is shown generally at 100. The system defines a water pathway having a main inlet 102 for engagement with raw, brown or black water, which may contain sediment, pollutants, and the like, and an outlet 104 for outputting treated or remediated water in which the pollutants and other unwanted particles have been removed, generally. Although a simple rectangular tank is illustrated in FIG. 1, it should be understood that various sizes, shapes, vessel locations and numbers of components of various sizes may be employed.

Beginning now at main inlet 102, the system comprises a sensor housing 106, a first valve 108, a plurality of injector coils 110, an additive port 112, and a flow meter 114. As used herein, this area of the system may be referred to as “pre-cavitation zone” or “mixing zone.” The system may further comprise a first air injector 116 and a second sensor array 118, followed by vortex plate 146 and a second air injector 120. Additional sensors (e.g., pressure sensor 124) and a second valve 122 are also shown. The remediation pathway 101 then continues to the outlet 104. As used herein, this area of the system may be referred to herein as “cavitation zone” 144.

As can be seen in FIG. 1, the remediation channel 101 or “flow line” or “fluid line” is configured to introduce a fluid into the system 100 along a path represented by arrow A, using a pump 126. It should be appreciated that the remediation channel 101 may comprise varying shapes and sizes, and comprise numerous branches for purposes of injecting substances, and for quality testing. It should further be appreciated that the system may comprise multiple air actuators and multiple vortex generators that act as cavitation generators in the remediation channel 101. Furthermore, it will be appreciated that many types of cavitation generators may be used, for example, baffles, Venturi tubes, nozzles, orifices, slots, and so on. Also, in optional embodiments, a pump is not required as knetic energy from headwaters may be used to drive the system. As an example, river headwaters, or any downhill running waters provide pressure great enough to drive the system in circumstances.

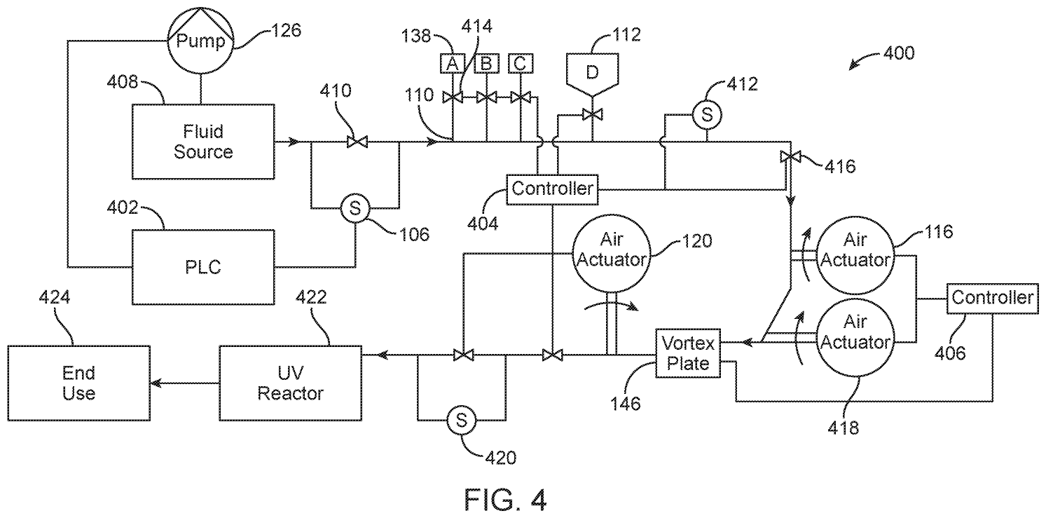

Referring still to FIG. 1, a sensor housing 106 is positioned proximate to the inlet 102 and is communicatively coupled to the remediation pathway 101 such that the remediation fluid is tested and monitored prior to entering the pre-cavitation zone. In optional embodiments of the present invention, a divergence pathway 128 and a valve 108 are provided such that a sample of the remediation fluid is off-shot for testing. An ingress pathway is further provided for injecting the testing fluid back into the remediation stream 101 via valve 134 (e.g., choke valve). The sensor housing 106 may comprise an array of sensors used for automation, characterization, and monitoring. For example, the sensor array may comprise a number of different components, including mechanical sensors, electronics, analytical and chemical sensors, control systems, telemetry systems, and software allowing the sensor to communicate with a Programmable Logic Controller (PLC), discussed in greater detail with relation of FIG. 4.

In embodiments of the present invention, the sensor housing 108 may comprise mechanical sensors, flow meters to measure flow rate and pressure gauges, electronic sensors to measure a variety of parameters such as pressure, specific gravity, the presence of liquid (water level meters and interface probes), pH, temperature, and conductivity, and analytical sensors to measure chemical parameters such as contaminant concentrations. Some examples of analytical sensors include pH probes and optical sensors used for colorimetric measurement. Control systems that work in conjunction with sensors comprise PLCs and other electronic microprocessor devices. Control systems are able to receive sensory inputs, process information, and trigger specific actions. These will be discussed in greater detail with relation to FIG. 4.

Referring still to FIG. 1, a plurality of leads 136 are fluidly coupled to the remediation path 101, the leads 136 being configured to inject certain substances into the remediation path. By way of example, different types and combinations of precursor compounds in solid, liquid or gas phase depending upon the type of fluid treatment process selected, the contaminants to be treated, the existing water quality, the desired water quality, and other variables may be employed. The precursor compounds 140 may be pumped into or injected into the remediation line 101 via pumps 138. The precursor compounds 140 can be feedstocks but also may comprise replaceable cartridges, and line feeds or other such like chemical inputs and for larger water flows bulk supply of the various feed stocks and precursor feed materials.

Exemplary compounds include compounds that may comprise halogen salts such as flourine, chlorine, bromine, iodine, sulphate salts, sodium, potassium and the like, introduced as solids or dissolved in water or some other solvent. Liquid feed stocks such as ozone, hydrogen peroxide, peroxyacids, brine solutions, chlorine solutions, ammonia solutions, amines, aldehydes, keytones, methanols, chelating agents, dispersing agents, nitrides, nitrates, sulfides, sulfates, and the like, dissolved in water or some other solvent may be employed. Further, gaseous feed stocks such as ozone, air, chlorine dioxide, oxygen, carbon dioxide, carbon monoxide, argon, krypton, bromine, iodine and the like may be employed, each of the foregoing in predetermined amounts based on the fluid remediation project goals.

For solid compounds, a dry agents lead 112 is shown. Injection of dry agents such as those discussed above may occur via the valve 142.

The ports for introducing the agent into the channel 101 may introduce the oxidizing agents into the flow-through channel at or near the local constriction of flow. In the illustrated example, the port may be configured to permit the introduction of the oxidizing agent into the fluid in the local constriction of flow. It will be appreciated that the ports may be configured to introduce oxidizing agents into the stream 101 not only at the local constriction of flow, but along an area between and including the local constriction of flow and the area into the cavitation zone, where cavitation bubbles are formed.

Still with reference to FIG. 1, and moving down the fluid flow path, additional sensors such as a flowmeter 114 is placed along the path. In the pre-cavitation zone, the flow-meter is configured to quantify the bulk fluid movement so as to allow the PLC to calculate cavitation variables, discussed in greater detail with reference to FIG. 4.

Entering into cavitation zone 144, the fluid undergoes varying degrees of cavitation and remediation. The cavitation zone may comprise a first air injector 116 configured to inject air into the stream 101, a reactor plate 146, a second air injector 120, and control valves 124 to control the proportion of flow through the cavitation zone and to control the average dwell time of fluid in the line/stream 101.

The first and second air injectors are configured to induce cavitation into the fluid to form vapor cavities in a liquid (i.e. small liquid-free zones, bubbles or voids), which occurs when the fluid is subjected to rapid changes of pressure that cause the formation of cavities where the pressure is relatively low. In this way, the injectors are used to enhance chemical reactions and propagate reactions due to free radicals formation in the process due to disassociation of vapors trapped in the cavitating bubbles.

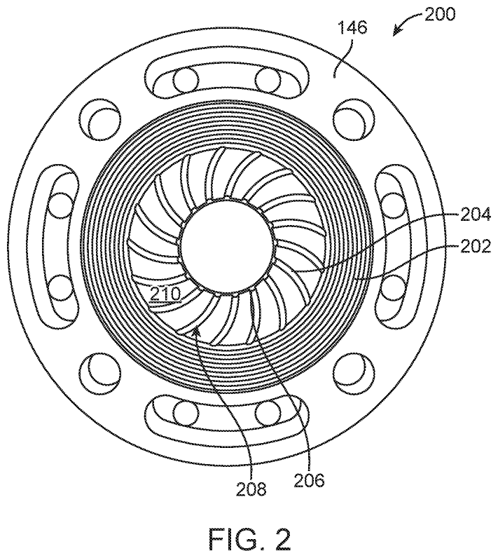

A reactor plate 146 is disposed within the line 101 between the first and second air injectors. The reactor plate, discussed in greater detail with relation to FIG. 2, is configured to induce further cavitation such that, in the cavitation zone 144, there are large quantities of micro bubbles having high volatility. When these micro bubbles collapse, instantaneous pressures up to 500 atmospheres and instantaneous temperatures of about 5000 degrees K are produced in the fluid. This phenomenon accomplishes several important chemical reactions: (1) H2O disassociates into OH radicals and H+ atoms; (2) chemical bonds of complex organic hydrocarbons are broken; and (3) long chain chemicals are oxidized into simpler chemical constituents, before being irradiated downstream by ultraviolet radiation, furthering the oxidation process.

An additional valve 124, e.g., butterfly valve, is disposed in the line to drop the head pressure when needed for egress of the fluid to outlet 104. The valve 124, like other valves in the system, is communicably coupled to the PLC such that it is fully autonomous.

Now with reference to FIG. 2, a front view of the reactor plate 146 of FIG. 1 in accordance with one embodiment of the present invention, is shown generally at 200. With reference back to FIG. 1, the substantially homogenously mixed stream is directed from the air injector 116 to the reactor plate 146. The reactor plate 146 comprises a center aperture of a predetermined size through which the fluid passes. Uniform striations 202 are disposed on the face of the plate 146, the number of which is predetermined based upon the use-case, and are configured to evenly disperse the fluid. The striations 202 in some embodiments are circular rings which form respective mountains and valleys over a predetermined portion of the face of the plate. In the embodiment shown in FIG. 2, the striations cover approximately half of the face of the plate from the outer radius inward. In some optional embodiments, the striations can act as seals with respect to the cavitation section. As can be seen in FIG. 1, flanges allow the sections to be easily replicable.

A vortex generation section 204 is disposed inwardly toward the center of the plate 146, and comprises a forward edge portion which slants first upwardly and rearwardly, and then curves in a continuous convex rearward curve, having valleys 208 and peaks 210 that blend into a substantially horizontal rearwardly extending upper edge portion. These peaks may be referred to as “vanes.” This formation ensures that the bubbles begin forming at a size small enough to create a long range of hydrophobic forces that promotes bubble/particle attachment, and creates optimum size and number of bubbles in a continually changing mixing environment. The plate 146 enhances the amount of hydroxyl radicals generally may be capable of degrading and/or oxidizing organic compounds in a fluid, and results in significant amounts of oxidizing agents contained within and/or associated with the cavitation bubbles.

The reactor plate 146 may be formed of a material that is relatively impervious to cavitation's, such as a metal alloy, or in some embodiments, a resilient elastomeric material. The reactor plate 146 may be embodied in a variety of different shapes and configurations. For example, the plate may be conically shaped, including a conically-shaped surface that induces a vortex, or may be fully cyclical as shown. It should be appreciated other shapes may be employed as well to a varying degree.

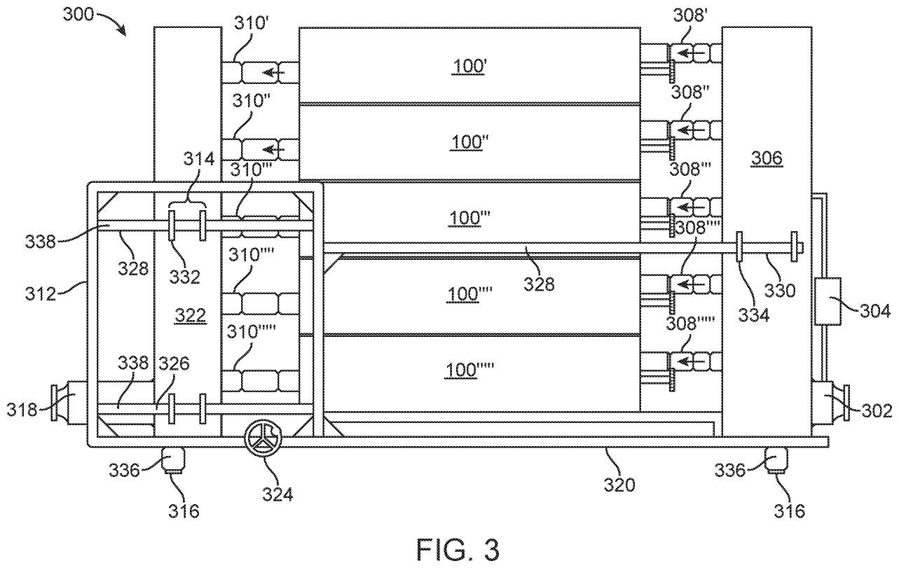

Referring now to FIG. 3 a schematic diagram of the fluid water treatment system of FIG. 1 “scaled-up” in accordance with one embodiment of the present invention, is shown generally at 300. Many water remediation treatments require “large scale” treatment, and thus, high throughput. As such, the present invention is configured to easily scale up to combine multiple systems to optimize and increase fluid throughput. The ability to easily assemble units together into a single large unit (e.g., stackable units) enables augmented solutions for every size remediation project. The stacked system comprises mass inlet 302, inlet manifold 306, a plurality of mid-inlet pipes 308, a plurality of remediation systems 100, a plurality of mid-output pipes 310, an output manifold 322, a mass outlet 318, and a mechanical actuator frame 314.

Mass inlet 302 is sized for high throughput and is connected to, and in fluid communication with, an input manifold 306. The input manifold 306 is a hydraulic manifold that is configured to regulate fluid flow into the systems stacked system 100. The input hydraulic manifold 306 comprises a plurality of hydraulic valves and pathways connected to each other. It is the various combinations of states of these valves that allow for fluid behavior control in the manifold. As one example of many known functions of manifold, the input manifold 316 is configured to ensure approximately equal amounts of fluid are diverted to each of the stacked systems to optimize throughput. The input manifold 316, in some embodiments, may be fitted with a sensor array similar to the sensor array of FIG. 1, sensor housing 106. Similarly, the manifold may be in electronic communication with the PLC, discussed in greater detail with relation to FIG. 4.

Mid-input connector lines 308ⁱ-308ⁱⁱⁱⁱⁱ connect the manifold 306 to each of the remediation systems 100ⁱ100ⁱⁱⁱⁱⁱ, respectively, and fluid remediation path 101 within the systems (see FIG. 1). It should be appreciated that not all components of system 100 are required in this stacked arrangement 300 and that some elements will change as to form but perform a similar function. As an example, dry agent housing at 112 may not be required, nor would multiple pumps as they would be redundant.

Mid-output connector lines 310ⁱ⁻ⁱⁱⁱⁱⁱ are in fluid communication with an output manifold 322. The output manifold, like the input manifold 306 is a hydraulic manifold, but in this case, is configured to regulate fluid flow outbound the systems stacked system 100. The output hydraulic manifold 322 comprises a plurality of hydraulic valves and pathways connected to each other. It is the various combinations of states of these valves that allow for fluid behavior control in the manifold. As one example of many known functions of manifold, the output manifold 322 is configured to ensure optimized mixing of fluids prior to egress from the systems via mass output 318. The output manifold 322, in some embodiments, may be fitted with a sensor array similar to the sensor array of FIG. 1, sensor housing 106, specifically, to counter any overpressure in the system. Similarly, the manifold may be in electronic communication with the PLC, discussed in greater detail with relation to FIG. 4.

In operation, in the system of FIG. 3, fluid enters the mass inlet 302, passes through input manifold 306 and into each of the mid-input pipes 308, then through the remediation pathway system 100, at which point the fluid undergoes explosive cavitation and is remediated and output to mid-output pips 310, into output manifold 322, and outlets through mass output 318.

Referring still to FIG. 3, a mechanical lifting system 314 is shown. The mechanical lifting system 314 is configured to safely and conveniently stack and unstack remediation systems 100 dependent upon the required fluid throughput for a remediation project.

The mechanical lifting system comprises base 320, actuator 324, legs 316, which may be connected to a lifting jack 336 configured to provide a motive force to ascend and descend during stack configuration. It is noted that for the weight supported by the base may be in the order of 10-250 tons. FIG. 3 shows only two lifting jacks 336 of the lifting system 314, however, more lifting jacks may be used. The lifting jacks 336 may be connected via hydraulic hoses to a hydraulic pump to provide motive force. A control system (e.g., PLC), which may include a computer with a touch screen, keyboard, mouse, screen, etc. is connected to the hydraulic pump is configured to control the lift applied by the lifting jacks 336. According to one exemplary embodiment, the control system 108 may be configured to control each lifting jack independently, or some or all of the lifting jacks 102 simultaneously to produce a same or different amount of lift.

Referring still to FIG. 3, the lifting system 314 further comprises a side plate 338, which is configured for connection to the manifold 322 on one end, and a manifold 306 on the other end via connectors 332 and 334. While bars are shown in FIG. 3, a large plate may be used as well. The lifting system 314 may also comprise crawlers to provide a motive force in a horizontal direction.

Referring now to FIG. 4., a schematic of a fluid remediation system together with the intelligent platform and automation hardware/software arrangement in accordance with one embodiment of the present invention, is shown generally at 400. “Intelligent platform,” generally, relates to controls such as programmable logic controls, high performance and high-performance system (e.g., PACSystems) controllers, having availability redundancy, expandable open architectures, upgradeable CPUs and the like. Further, in embodiments of the present inventions, distributed I/O utilizing PROFINET® to maximize efficiency and data dissemination, have I/O flexibility and connect to a full range of I/O, from simple discrete to safety and process I/O.

As shown in FIG. 4. a PLC 402 is in electronically coupled (e.g., hardwire, wireless, Bluetooth®, etc.) with a plurality of controllers 404, 406, 408, each being coupled to various valves and sensor arrays. The PLC 402 is configured to execute software which continuously gathers data on the state of input devices to control the state of output devices. As is known, the PLC typically comprises a processor (which may include volatile memory), volatile memory comprising an application program, and one or more input/output (I/O) ports for connecting to other devices in the automation system. Additionally, in PLCs, context knowledge about the process available on control level is lost for the business analytics applications. The platform may further comprise higher level software functionality in Supervisory Control and Data Acquisition (SCADA), Manufacturing Execution Systems (MES), or Enterprise Resource Planning (ERP) systems. Optionally, the PLC may be an “Intelligent PLC,”, which comprises various components which may be configured to provide an assortment of enhanced functions in control applications. For example, in some embodiments, the Intelligent PLC includes a deeply integrated data historian and analytics functions. This technology is particularly well-suited for, but not limited to, various industrial automation settings for water remediation. In operations, the automation system context information may include, for example, one or more of an indication of a device that generated the data, a structural description of an automation system comprising the Intelligent PLC, a system working mode indicator, and information about a product that was produced when the contents of the process image area were generated. Additionally, or alternatively, the contextualized data may include one or more of a description of automation software utilized by the Intelligent PLC or a status indictor indicative of a status of the automation software while the contents of the process image area were generated.

Referring still to FIG. 4, the PLC is electronically coupled to a pump 124 and the fluid source 408, a sensor housing 106, a valve 410, a plurality of injector coils 110, an additive port 112 and another sensory array 114. An additional down-line controller 404 is communicatively coupled to the PLC and in further communication with the additive ports 112 and 138. In optional embodiments of the present invention, the sensor array 106 is configured to retrieve all of the relevant properties of fluid and send that information to the PLC for 402. Based on the properties of the fluid the PLC is configured to direct valves 414 to release agents into the stream that support the remediation process. The PLC 402, in some embodiments, is loaded with predetermined information regarding the quality of the fluid. By way of example, different types and combinations of precursor compounds in solid, liquid or gas phase depending upon the type of fluid treatment process selected, the contaminants to be treated, the existing water quality, the desired water quality, and other variables may be employed such as compounds that may comprise halogen salts such as fluorine, chlorine, bromine, iodine, sulfate salts, sodium or potassium or the like introduced as solids, or dissolved in water, or other solvent.

An additional sensor array 412 is provided for testing and gathering data on the treated fluid, and to ensure proper pressures and flow rate may be provided. Should the fluid properties be outside of a predetermined range another valve for 16 is provided shoe stop the flow of fluid.

First air injector 116 is in communication with an additional controller 406, which is in turn, in communication with PLC 402. In an optional embodiment of the present invention, the PLC 402 is configured to control air pressure based on the degree of cavitation required. The controller 406 is also in communication with the reactor plate 146 and a baffle (not shown) to rotate and tilt the reactor plate to vary the degrees of cavitation. Like the first air injector, a second air injector 120 and control valves 124 are in communication with the controller 406 for similar purposes.

Still with reference to FIG. 4, an additional actuator 418 may be employed, as may an optional sensor array 420 and UV reactor 422, each being connected to the controller prior to end use remediated fluid 424.

The first and second air injectors are configured to induce cavitation into the fluid to form vapor cavities in a liquid (i.e. small liquid-free zones, bubbles or voids), which occurs when the fluid is subjected to rapid changes of pressure that cause the formation of cavities where the pressure is relatively low. In this way, the injectors are used to enhance chemical reactions and propagate reactions due to free radical formation in the process due to disassociation of vapors trapped in the cavitating bubbles.

A reactor plate 146 is disposed within the line 101 between the first and second air injectors and is communication with the PLC 402, and the PLC 402 is configured to tilt the reactor plate 146 in various directions (e.g., 15 degrees). The reactor plate, discussed in greater with relation to FIG. 2, is configured to induce further cavitation such that, in the cavitation zone 144, there are large quantities of micro bubbles having high volatility.

An additional valve 124, e.g., butterfly valve, is disposed in the line to drop the head pressure when needed for egress of the fluid to outlet 104. The valve 124, like other valves in the system, is communicably coupled to the PLC such that it is fully autonomous.

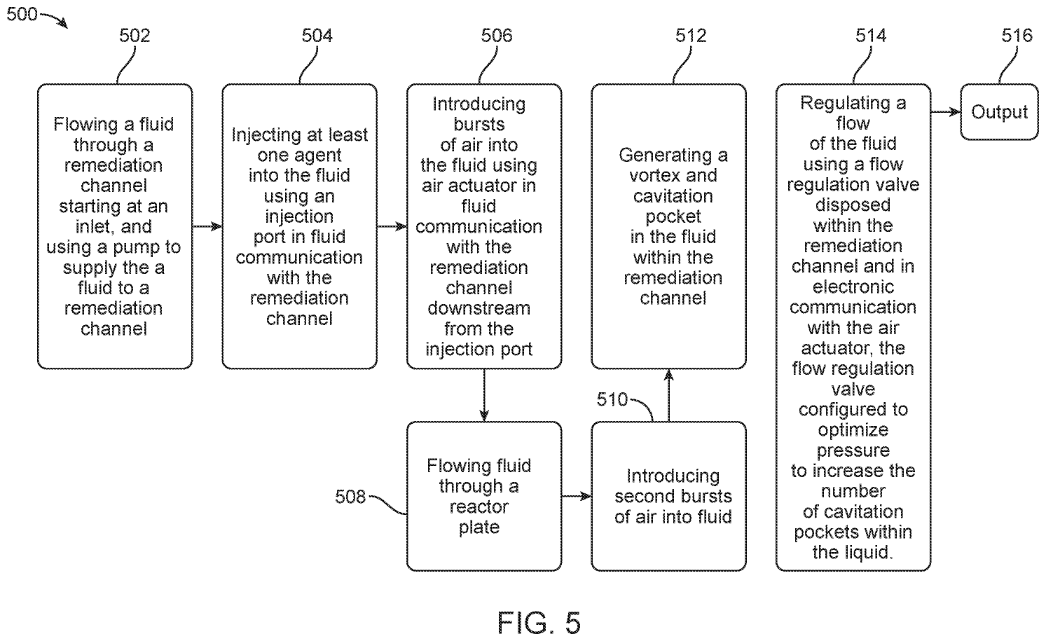

FIG. 5 is a flow diagram illustrating an example method 500 for cavitation-based fluid treatment in accordance with one embodiment of the present invention. Method 500 may comprise flowing a fluid containing organic compounds into remediation channel, step 502.

The method may further comprise injecting at least one agent into the fluid using an injection port in fluid communication with the remediation channel, step 504.

The method may further comprise introducing bursts of air into the fluid using air actuator in fluid communication with the remediation channel downstream from the injection port, step 506.

The method may further comprise flowing fluid through a reactor plate to create a cortex, step 508.

The method may further comprise introducing bursts of air into the fluid using air actuator at a second location in fluid communication with the remediation channel downstream from the injection port, step 510.

The method may further comprise generating at least one and more often a plurality of vortices vortex and cavitation pocket in the fluid within the remediation channel step 512.

The method may further comprise regulating a flow of the fluid using a flow regulation valve disposed within the remediation channel and in electronic communication with the air actuator, the flow regulation valve configured to optimize pressure to increase the number of cavitation pockets within the liquid, step 512, and outputting the remediated fluid step 516.

### EXAMPLE

The example is for the purpose of illustrating an embodiment and is not to be construed as a limitation.

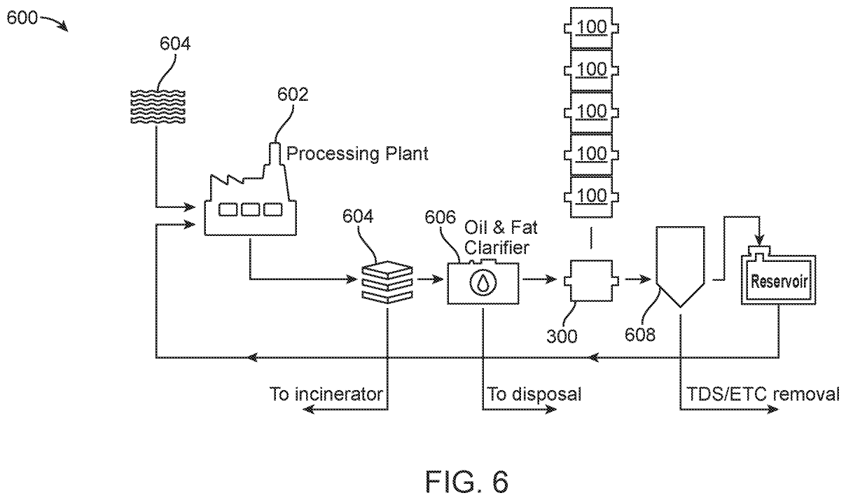

Example 1, FIG. 6, shows a use case for removal of contaminants from a fluid by cavitation-based treatment of the fluid that is contaminated based on various farming practices using the system and method of FIGS. 1-5. Biotic and abiotic byproducts of farming practices result in contamination or degradation of the environment and surrounding ecosystems. The pollution may come from a variety of sources, ranging from point source pollution (from a single discharge point) to more diffuse, landscape-level causes, also known as non-point source pollution. Example pollutants include fluoride, lead, arsenic, cadmium, chromium, selenium, and nickel. Organic manures are also contaminants that may be treated using the exemplary process.

A shown in FIG. 6, a farm (processing plant) is shown at 602 in fluid communication with an input of water 604 used for processing product. The output brown or contaminated water is channeled to a solid screening to remove waste solids prior to entering an oil and fat clarifiers to break down and strain fatty organic materials from animals, vegetables, and petroleum. The resulting fluid is then channeled to the cavitation remediation system of FIG. 3, which comprises the stacked cavitation systems 300. Once the water is remediated, it is channeled to finishing tanks 608 for various uses.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A system for remediation of a fluid, the system comprising:
an inlet configured to supply the fluid to a remediation channel;
an injection port in fluid communication with the remediation channel, the injection port configured to inject at least one substance into the liquid;
at least on air actuator in fluid communication with the remediation channel downstream from the injection port, the air actuator configured to generate a cavitation pocket; and
a vortex plate disposed within the remediation channel, and configured to create a swirl in the fluid and further increase a number of cavitation pockets within the liquid.

2. The system of claim 1, wherein the injection ports comprise a plurality of injection ports, a first of the plurality of injection ports configured to inject a liquid or gaseous agent, a second of the plurality of injection ports configured to inject a dry agent into the remediation channel.

3. The system of claim 1, further comprising a flow regulation valve disposed within the remediation channel and in electronic communication with the air actuator, the flow regulation valve configured to optimize pressure to further increase the number of cavitation pockets within the liquid.

4. The system of claim 1, further comprising a pump in fluid communication with the inlet and configured force fluid into the remediation pathway.

5. The system of claim 1, further comprising at least one sensor array in electronic communication with a programmable logic controller, and configured to measure a plurality of fluid characteristics within the remediation channel.

6. The system of claim 5, wherein the fluid characteristics measured by at least one sensor comprises at least one of acoustic sensors, chemical sensors, flow and fluid velocity sensors, optical sensors, pressure sensors, density sensors, and thermal sensors.

7. The system of claim 5, wherein the at least one sensor array comprises a plurality of sensor arrays disposed in a plurality of positions along the remediation channel

8. The system of claim 1, further comprising a second air actuator in fluid communication with the remediation channel downstream from the first air actuator and configured to generate a second vortex and additional cavitation pockets.

9. The system of claim 1, wherein the remediation system is combinable with further remediation systems using a lifting system, the lifting system being attachable to the remediation system via connection members, and comprising:
an actuator coupled to a lifting jack, the lifting jack configured to provide a motive force to ascend and descend during configuration;
a side plate configured for connection to an inlet manifold on one end of the remediation system; and
at least a crawler configured to provide a motive force in a horizontal direction.

10. The system of claim 5, further comprising a plurality of butterfly valves disposed on the remediation channel, and in electronic communication with the programmable logic controller, and configured to optimize fluid pressure prior to each cavitation event.

11. A method for remediation of a fluid, the method comprising:
flowing a fluid through a remediation channel;
injecting at least one substance into the fluid using an injection port in fluid communication with the remediation channel;
introducing bursts of air into the fluid using air actuator in fluid communication with the remediation channel downstream from the injection port;
generating a vortex and cavitation pocket in the fluid within the remediation channel; and
inducing a second vortex in the fluid using a vortex plate disposed within the remediation channel, and configured to create a swirl in the fluid and further increase the number of cavitation pockets within the liquid.

12. The method of claim 11, further comprising injecting an agent into the fluid, wherein the injection ports comprise a plurality of injection ports, a first of the plurality of injection ports configured to inject a fluid or gaseous agent, a second of the plurality of injection ports configured to inject a dry agent into the remediation channel.

13. The method of claim 11, wherein the injection steps occur using a plurality of vessels in fluid communication with the injection ports and configured to supply the agents to the ports for injection into the remediation channel.

14. The method of claim 11, further comprising regulating a flow of the fluid using a flow regulation valve disposed within the remediation channel and in electronic communication with the air actuator, the flow regulation valve configured to optimize pressure to increase the number of cavitation pockets within the liquid.

15. The method of claim 11, further comprising sensing a plurality of fluid parameters using at least one sensor array in electronic communication with a programmable logic controller and configured to measure a plurality of liquid characteristics within the remediation channel.

16. The method of claim 15, wherein the liquid characteristics measured by the at least one sensor comprises at least one of acoustic sensors, chemical sensors, flow and fluid velocity sensors, optical sensors, pressure sensors, density sensors, and thermal sensors.

17. The method of claim 15, wherein the at least one sensor array comprises a plurality of sensor arrays disposed in a plurality of positions along the remediation channel.

18. The method of claim 11, further inducing a second vortex in the fluid using a second vortex impeller disposed within the remediation channel, and configured to create a swirl in the fluid and further increase the number of cavitation pockets within the liquid.

19. The method of claim 11, further comprising combining multiple cavitation systems using a lifting system, the lifting system being attachable to the remediation system via connection members, and comprising:
an actuator coupled to a lifting jack, the lifting jack configured to provide a motive force to ascend and descend during configuration;
a side plate configured for connection to an inlet manifold on one end of the remediation system; and
at least a crawler configured to provide a motive force in a horizontal direction.

20. The method of claim 15, further comprising controlling fluid flow using a plurality of butterfly valves disposed on the remediation channel, and in electronic communication with the programmable logic controller, and configured to optimize fluid pressure prior to each cavitation event.
